(19) United States
(12) Patent Application Publication
(10) Pub. No.: US 2022/0272232 A1
(43) Pub. Date: Aug. 25, 2022

(54) IMAGE FORMING APPARATUS, IMAGE FORMING METHOD, AND A NON-TRANSITORY COMPUTER-READABLE RECORDING MEDIUM THAT STORES AN IMAGE FORMING PROGRAM

(71) Applicant: KYOCERA Document Solutions Inc., Osaka-shi (JP)

(72) Inventor: Hideya MURAMOTO, Osaka-shi (JP)

(21) Appl. No.: 17/668,624

(22) Filed: Feb. 10, 2022

(30) Foreign Application Priority Data
Feb. 15, 2021 (JP) 2021-021961

(51) Int. Cl. H04N 1/60

(52) U.S. Cl. CPC H04N 1/6044; H04N 1/6008; H04N 1/6027

(57) ABSTRACT

An image forming apparatus includes an image reading unit, an image forming unit, and a color calibration processing unit. The image forming unit forms an image on an image forming medium using image forming color materials of a plurality of colors including CMY. The color calibration processing unit sets, in consideration of the integrated value of the product of the spectral transmittance and the spectral reflectance in the visible region of the reference document measured by the external colorimeter and the color material image formed using the image forming color materials on the image forming medium, a difference feature amount for bringing the color of the color material image closer to the color of the reference document by using the integrated value of the product of the spectral transmittance and the spectral reflectance in the visible region calculated from the XYZ values measured by the external colorimeter.

### INCORPORATION BY REFERENCE

This application is based upon and claims the benefit of priority from the corresponding Japanese Patent Application No. 2021-021961 filed on Feb. 15, 2021, the entire contents of which are incorporated herein by reference.

### BACKGROUND

The present disclosure relates to image forming apparatus, image forming method, and a non-transitory computer-readable recording medium that stores an image forming program.

In recent years, there has been an increasing need for color printing with high image quality in image forming apparatuses. In order to realize such image reproduction, it is also necessary to appropriately perform calibration processing including adjustment of a color profile in order to suppress variation of colors caused by secular change of the image forming apparatus and variation among individuals, that is, individual differences. Individual differences also occur due to variations in the chromaticity of the light source of the image reading unit and variations in the layer thickness of the color filter. Such individual differences in the image reading unit adversely affect color calibration performed using the image reading unit. To solve such a problem, a technique has been proposed in which an in-line scanner and an in-line colorimeter are mounted in an image forming apparatus, and an individual conversion formula of an RGB value and a toner density (XYZ value) is generated in the image forming apparatus.

### SUMMARY

An image forming apparatus is capable to perform color calibration by using a reference document generated by offset printing using reference inks of a plurality of colors including CMY, and an external colorimeter capable of measuring a spectral reflectance in a visible region and an XYZ value.

The image forming apparatus includes an image reading unit, an image forming unit, and a color calibration processing unit.

The image reading unit reads an image on a document to generate image data. The image forming unit forms an image on an image forming medium using image forming color materials of a plurality of colors including CMY.

The color calibration processing unit sets, in consideration of the integrated value of the product of the spectral transmittance and the spectral reflectance in the visible region of the reference document measured by the external colorimeter and the color material image formed using the image forming color materials on the image forming medium, a difference feature amount for bringing the color of the color material image closer to the color of the reference document by using the integrated value of the product of the spectral transmittance and the spectral reflectance in the visible region calculated from the XYZ values measured by the external colorimeter.

The color calibration processing unit corrects each gradation value of RGB obtained by reading the reference document by the image reading unit by multiplying the gradation value by the difference feature amount, generates, by using the corrected each gradation value of RGB and each device-independent value obtained by measuring the reference document by the external colorimeter, a conversion formula from the obtained each gradation value of RGB to the each device-independent value, and generates a color profile by using the conversion formula.

The difference feature amount includes a linear correction amount that is a ratio set based on linearity between the spectral reflectance in the visible region of the color material image and the spectral reflectance in the visible region of the reference document, and a nonlinear correction amount that represents non-linearity between the spectral reflectance in the visible region of the color material image and the spectral reflectance in the visible region of the reference document.

An image forming method is capable to perform color calibration by using a reference document generated by offset printing using reference inks of a plurality of colors including CMY, and an external colorimeter capable of measuring a spectral reflectance in a visible region and an XYZ value.

The image forming method includes an image reading step, an image forming step, and a color calibration processing step.

The image reading step has a step of reading an image on a document to generate image data.

The image forming step has a step of forming an image on an image forming medium using image forming color materials of a plurality of colors including CMY.

The color calibration processing step sets, in consideration of the integrated value of the product of the spectral transmittance and the spectral reflectance in the visible region of the reference document measured by the external colorimeter and the color material image formed using the image forming color materials on the image forming medium, a difference feature amount for bringing the color of the color material image closer to the color of the reference document by using the integrated value of the product of the spectral transmittance and the spectral reflectance in the visible region calculated from the XYZ values measured by the external colorimeter.

The color calibration processing step has a step of correcting each gradation value of RGB obtained by reading the reference document by the image reading unit by multiplying the gradation value by the difference feature amount, generating, by using the corrected each gradation value of RGB and each device-independent value obtained by measuring the reference document by the external colorimeter, a conversion formula from the obtained each gradation value of RGB to the each device-independent value, and generating a color profile by using the conversion formula.

The difference feature amount includes a linear correction amount that is a ratio set based on linearity between the spectral reflectance in the visible region of the color material image and the spectral reflectance in the visible region of the reference document, and a nonlinear correction amount that represents non-linearity between the spectral reflectance in the visible region of the color material image and the spectral reflectance in the visible region of the reference document.

A non-transitory computer-readable recording medium that stores an image forming program stores an image forming program to control an image forming apparatus.

An image forming apparatus is capable to perform color calibration by using a reference document generated by offset printing using reference inks of a plurality of colors including CMY, and an external colorimeter capable of measuring a spectral reflectance in a visible region and an XYZ value.

The image forming program causes the image forming apparatus to function as an image reading unit, an image forming unit, and a color calibration processing unit.

The image reading unit reads an image on a document to generate image data. The image forming unit forms an image on an image forming medium using image forming color materials of a plurality of colors including CMY.

The color calibration processing unit sets, in consideration of the integrated value of the product of the spectral transmittance and the spectral reflectance in the visible region of the reference document measured by the external colorimeter and the color material image formed using the image forming color materials on the image forming medium, a difference feature amount for bringing the color of the color material image closer to the color of the reference document by using the integrated value of the product of the spectral transmittance and the spectral reflectance in the visible region calculated from the XYZ values measured by the external colorimeter.

The color calibration processing unit corrects each gradation value of RGB obtained by reading the reference document by the image reading unit by multiplying the gradation value by the difference feature amount, generates, by using the corrected each gradation value of RGB and each device-independent value obtained by measuring the reference document by the external colorimeter, a conversion formula from the obtained each gradation value of RGB to the each device-independent value, and generates a color profile by using the conversion formula.

The difference feature amount includes a linear correction amount that is a ratio set based on linearity between the spectral reflectance in the visible region of the color material image and the spectral reflectance in the visible region of the reference document, and a nonlinear correction amount that represents non-linearity between the spectral reflectance in the visible region of the color material image and the spectral reflectance in the visible region of the reference document.

### BRIEF DESCRIPTION OF THE DRAWINGS

FIG. 1 is a schematic configuration diagram showing the overall configuration of an image forming apparatus according to an embodiment of the present disclosure.

FIG. 2 is a block diagram showing a functional configuration of an image forming apparatus according to an embodiment.

FIG. 3 is a flowchart showing the contents of the profile calibration process according to an embodiment.

FIGS. 4A and 4B are each an explanatory diagram showing the contents of the external colorimetry processing according to an embodiment.

FIGS. 5A, 5B, and 5C are each an explanatory diagram showing the contents of the RGB arithmetic processing of the toner reproduction color according to an embodiment.

FIGS. 6A, 6B and 6C are each an explanatory diagram showing the contents of the RGB arithmetic processing of the ink reproduction color according to an embodiment.

FIGS. 7A and 7B are each a graph showing the product of the spectral reflectance and the filter transmittance in the visible band according to an embodiment.

FIGS. 8A and 8B are each an explanatory diagram showing a spectral reflectance difference and a difference feature amount according to an embodiment.

### DETAILED DESCRIPTION

Hereinafter, embodiments for implementing the present disclosure will be described in the following order with reference to the drawings.

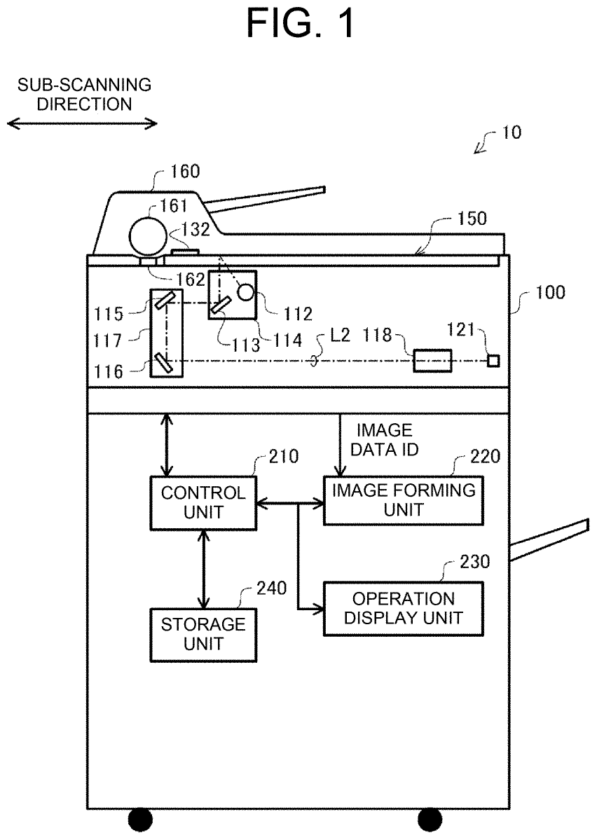

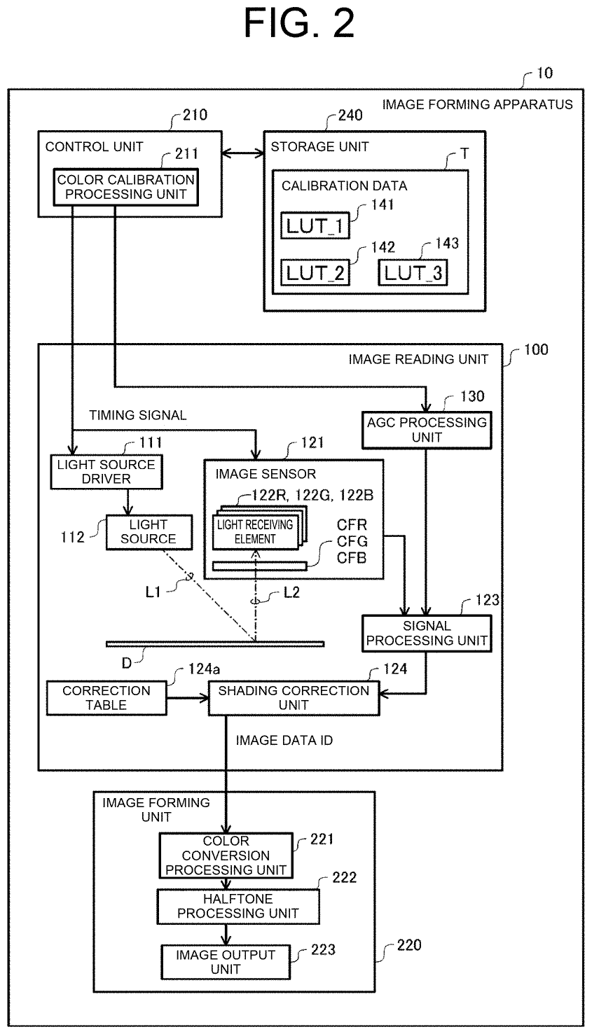

FIG. 1 is a schematic configuration diagram showing the overall configuration of an image forming apparatus 10 according to an embodiment of the present disclosure. FIG. 2 is a block diagram showing a functional configuration of an image forming apparatus 10 according to an embodiment. The image forming apparatus 10 includes an image reading unit 100, a control unit 210, an image forming unit 220, an operation display unit 230, and a storage unit 240. The image reading unit 100 includes an automatic document feeder (ADF) 160 and a document platen (contact glass) 150, and reads an image (original image) from the document to generate an image data ID as digital data.

An image forming unit 220 forms an image on a printing medium (also referred to as an image forming medium) based on the image data ID and ejects the printing medium. The image forming unit 220 includes a color conversion processing unit 221, a halftone processing unit 222, and an image output unit 223. A color conversion processing unit 221 performs color conversion of image data ID being RGB data into CMYK image data. The CMYK image data is color material gradation data having color material gradation values representing respective densities of a plurality of color materials (for example, CMYK).

A halftone processing unit 222 executes halftone processing to generate halftone data of CMYK image data. An image output unit 223 forms an image based on halftone data. The operation display unit 230 receives user operation input from a display (not shown) functioning as a touch panel, various buttons, and switches (not shown).

The control unit 210 includes main storage means such as RAM and ROM, and control means such as Micro Processing Unit (MPU) and Central Processing Unit (CPU). The control unit 210 has controller functions related to various I/O, universal serial bus (USB), bus, and other interfaces including hardware, and controls the entire image forming apparatus 10. The control unit 210 has a color calibration processing unit 211. The function of the color calibration processing unit 211 will be described later.

The storage unit 240 is a storage device including a hard disk drive, a flash memory, or the like, which is a non-temporary recording medium, and stores control programs (including an image forming program) and data for processing executed by the control unit 210. The storage unit 240 further stores spectral transmittances of the RGB color filters CFR, CFG, and CFB at respective wavelengths λ nm in the visible region.

As shown in FIG. 2, the image reading unit 100 includes a light source driver 111 and a light source 112. The light source 112 has a plurality of LEDs (not shown) for irradiating the document D with light. The light source driver 111 is an LED driver for driving a plurality of LEDs arranged in the main scanning direction, and controls on/off driving of the light source 112. Thus, the light source 112 can irradiate the document surface of the document D with the irradiation light L1 by pulse width modulation (PWM) of variable drive duty. The light source 112 generally has chromaticity variations.

The irradiation light L1 is irradiated at an angle of 45 degrees (inclined direction) with respect to a direction perpendicular to the surface of the document D. The document D reflects reflection light including diffuse reflection light L2 and regular reflection light. The light receiving element 122 receives the diffused reflection light L2.

As shown in FIG. 1, the image reading unit 100 further includes a first reflecting mirror 113, a first carriage 114, a second reflecting mirror 115, a third reflecting mirror 116, a second carriage 117, and a condensing lens 118 between the document D and the image sensor 121. The first reflecting mirror 113 reflects the diffused reflection light L2 from the document D in the direction of the second reflecting mirror 115. The second reflecting mirror 115 reflects the diffused reflection light L2 in the direction of the third reflecting mirror 116. The third reflecting mirror 116 reflects the diffused reflection light L2 in the direction of the condensing lens 118. The condensing lens 118 forms an image of the diffused reflection light L2 on each light receiving surface (not shown) of the plurality of light receiving elements 122 (122R, 122G, 122B) of the image sensor 121.

The three light receiving elements 122R, 122G, and 122B are three CCD line sensors (not shown) for detecting three colors of R, G, and B by using color filters CFR, CFG, and CFB of each color component of R, G, and B, respectively. The image sensor 121 scans (sub-scans) a document by three CCD line sensors extending in the main scanning direction, and acquires an image on the document as a combination of voltage values corresponding to R, G, and B. In this way, the image sensor 121 can output analog electric signals of R, G, and B for each pixel in the main scanning direction by performing photoelectric conversion processing. The color filters CFR, CFG, and CFB generally have variations in layer thickness.

The first carriage 114 mounts the light source 112 and the first reflecting mirror 113 and reciprocates in the sub-scanning direction. The second carriage 117 mounts thereon the second reflecting mirror 115 and the third reflecting mirror 116 and reciprocates in the sub-scanning direction. The first carriage 114 and the second carriage 117 are controlled by a control unit 210 functioning as a scanning control unit. Thus, since the light source 112 can scan the document in the sub-scanning direction, the image sensor 121 can output an analog electric signal in accordance with a two-dimensional image on the document.

When the automatic document feeder (ADF) 160 is used, the first carriage 114 and the second carriage 117 are fixed to predetermined sub-scanning positions, and scanning in the sub-scanning direction is performed by automatic feeding of the document D. The ADF 160 may read not only one side but also both sides simultaneously or sequentially.

The ADF 160 includes a paper feed roller 161 and a document reading slit 162. The paper feed roller 161 automatically feeds the document and reads the document through the document reading slit 162. In this case, since the first carriage 114 is fixed at a predetermined sub-scanning position, the light source 112 mounted on the first carriage 114 is also fixed at a predetermined position.

As shown in FIG. 2, the image reading unit 100 further includes a signal processing unit 123, a shading correction unit 124, a shading correction table 124a, an automatic gain control (AGC) processing unit 130, and a white reference plate 132 (see FIG. 1).

The signal processing unit 123 is a variable gain amplifier having an A/D conversion function. A signal processing unit 123 amplifies an analog electric signal by a gain set in an AGC processing unit 130 and stored in a storage unit 240, and A/D converts the amplified analog electric signal to digital data.

In the present embodiment, the AGC processing unit 130 is a gain adjustment section for setting an optimum gain and an offset value for each of the plurality of light receiving elements 122 using the black reference signal and the white reference signal. The black reference signal is an analog electric signal of the light receiving element 122 in a state where the light source 112 is turned off. The white reference signal is an analog electric signal of the light receiving element 122 when the white reference plate 132 is irradiated instead of the document D.

The AGC processing unit 130 sets the offset value so that each gradation value of RGB of the image data ID when the black reference signal is A/D-converted by the signal processing unit 123 becomes the minimum value “0”. The AGC processing unit 130 uses the offset value to set the gain so that each gradation value of RGB of the image data ID becomes the maximum value “255” when the white reference signal is A/D-converted by the signal processing unit 123. Thus, the dynamic range from the minimum value “0” to the maximum value “255” can be effectively utilized.

A shading correction unit 124 performs shading correction on the digital data to generate an image data ID. The shading correction is a correction for suppressing shading caused by unevenness of light quantity in the length direction of the light source 112, peripheral dimming by the cosine fourth power law of the lens, and unevenness in sensitivity of the plurality of light receiving elements 122 arranged in the main scanning direction. Thus, the image reading unit 100 can generate an image data ID having each gradation value of RGB.

The image reading unit 100 has a characteristic defined by the input profile. Using the input profile, the image data ID, which is device-dependent RGB image data, can be converted into image data in a device-independent color space, such as Lab image data, which is image data in the Lab color space, or XYZ image data, which is image data in the XYZ color space. Thus, the image forming apparatus 10 can realize conversion into, for example, sRGB image data or the like via a device-independent Lab color space or the like and output as scan data.

The image forming unit 220 has the characteristics defined in the output profile. By using the output profile, Lab image data and XYZ image data can be converted into CMYK image data which is image data in CMYK color space. The image forming apparatus 10 has a device link profile in which an input profile and an output profile are combined. The device link profile can improve the printing speed by reducing the load of the color conversion processing in the copying processing.

The input profile, the output profile, and the device link profile are each configured as look-up tables (LUT: LUT_1, LUT_2, LUT_3) 141˜143. The look-up tables (LUT) 141˜143 are stored in the storage unit 240. The look-up tables (LUT) 141˜143 are configured in the following manner to suppress individual differences in color reproduction in the image forming apparatus 10.

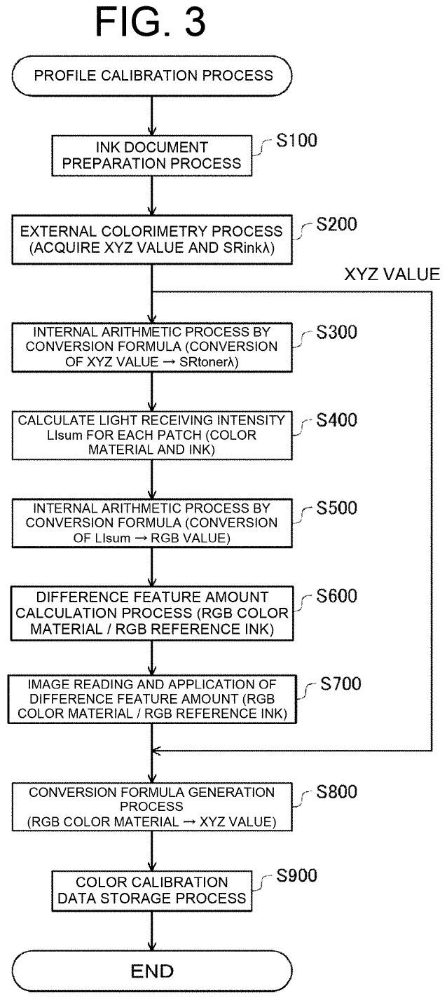

FIG. 3 is a flowchart showing the contents of the profile calibration process according to the embodiment. The profile calibration process can calibrate the input profile, the output profile, and the device link profile. Input profiles, output profiles, and device link profiles are also referred to as color profiles.

In step S100, the manufacturing (adjustment) person or the service person prepares an INK document printed by offset printing using the reference ink as the color material. This is because, unlike the electrophotographic process, printed matter produced by offset printing has small in-plane unevenness and high abrasion resistance. As a result, the INK document can be used for adjustment of a plurality of image forming apparatuses 10, and has an effect of reducing man-hours.

Typical printing methods include an offset printing method, an electro-photographic process method (electro-photographic method) using toner as an image forming color material, and an inkjet printing method (inkjet method) using ink as an image forming color material. The present embodiment uses an INK document printed by offset printing using a reference ink to realize calibration of printing methods other than offset printing, such as an electro-photographic process method and an inkjet printing method.

Offset printing uses plates for printing, and the ink adheres tightly to the paper, resulting in high-quality printing. The offset printing is characterized in that while it is possible to clearly express even the smallest details such as illustrations, photographs, and characters, there is little irregularity in solid image. Since the offset printing method uses a printing plate for printing, the cost is high if a large number of copies are not printed, but when a large number of copies are printed for distribution to service persons, there is a large advantage that variation in quality between printed materials is small and the cost is low.

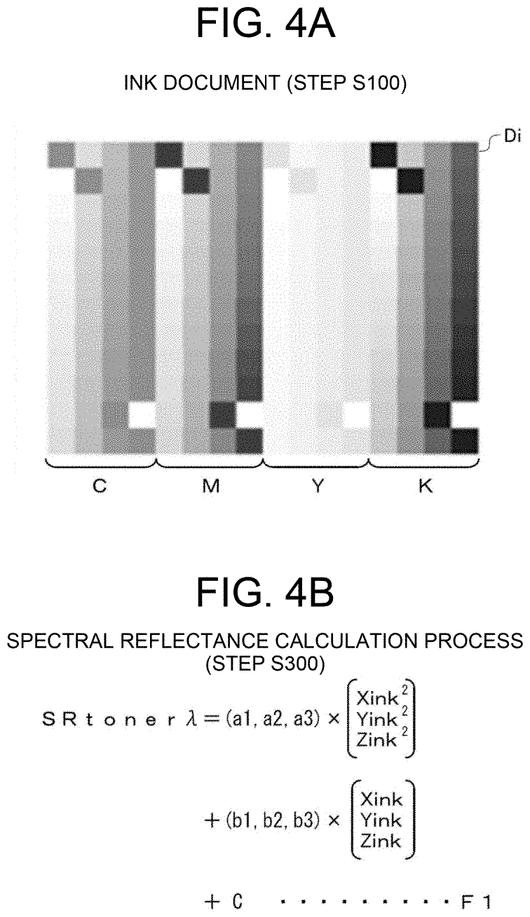

FIGS. 4A and 4B are each an explanatory diagram showing the contents of the external colorimetry processing according to one embodiment. FIG. 4A shows an example of the INK document Di. The INK document Di reproduces a chart including 48 gradation patches of each CMYK color material (reference ink) by offset printing. The INK document Di is also referred to as a reference document.

In step S200, the manufacturing (adjustment) person or the service person executes the external colorimetry process. In the external colorimetry process, the person in charge of manufacturing (adjusting) or the service person measures the XYZ value of the INK document Di and the ink spectral reflectance SRinkλ in the wavelength range of 400 nm to 730 nm by using a colorimeter (not shown) external to the image forming apparatus 10. The XYZ value and the ink spectral reflectance SRinkλ are measured for each patch of CMYK in the INK document Di. The external colorimeter (not shown) may be any measuring instrument capable of measuring the spectral reflectance in the visible region and the XYZ value.

In step S300, the color calibration processing unit 211 of the control unit 210 calculates the toner spectral reflectance SRtonerλ from the XYZ value using the second-order approximate conversion formula F1 (see FIG. 4B) previously stored in the storage unit 240. In this example, the toner spectral reflectance SRtonerλ is a simulated value of the spectral reflectance which is set in consideration of the spectral reflectance characteristics of a plurality of color materials (for example, CMYK toner) used by the image forming unit 220 for color reproduction, and in consideration of color reproduction of each XYZ value by the toner as the plurality of color materials.

The toner spectral reflectance SRtonerλ is a spectral reflectance at each wavelength λ nm for reproducing the XYZ value measured in the INK document Di. The toner spectral reflectance SRtonerλ is indirectly measured (contains simulation operations.) for each patch of CMYK in the INK document Di using a colorimeter (not shown). The order of the approximate conversion formula F1 is not limited to the second order, but may be equal to or greater than the second order.

In step S400, the color calibration processing unit 211 calculates an cumulative value of the light receiving intensity (or light receiving amount) in the visible band of the reflection light of the toner (an example of the image forming color material) received by the three light receiving elements 122R, 122G, and 122B, respectively, by using the calculation formulas F2r, F2g, and F2b and the calculation formulas F3r, F3g, and F3b.

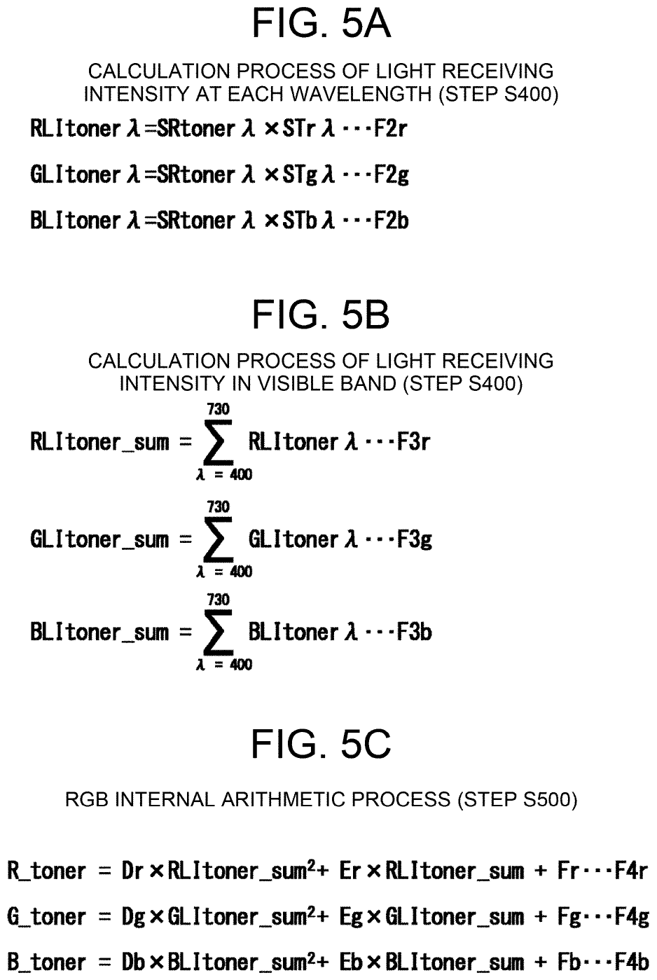

FIGS. 5A, 5B, and 5C are each an explanatory diagram showing the contents of the RGB arithmetic processing of the toner reproduction color according to the embodiment. FIG. 5A shows calculation formulas F2r, F2g, and F2b used for the light receiving intensity calculation processing for each wavelength. RLItonerλ of the calculation formula F2r is the light receiving intensity for each wavelength of R. SRtonerλ is the toner spectral reflectance. STrλ is the spectral transmittance at the wavelength λ nm of the R color filter CFR. GLItonerλ of the calculation formula F2g is the light receiving intensity for each wavelength of G. SRtonerλ is the toner spectral reflectance. STgλ is the spectral transmittance at the wavelength λ nm of the G color filter CFG. BLItonerλ of the calculation formula F2b is the light receiving intensity for each wavelength of B. SRtonerλ is the toner spectral reflectance. STbλ is the spectral transmittance at the wavelength λ nm of the B color filter CFB.

FIG. 5B shows calculation formulas F3r, F3g, and F3b used for the light receiving intensity calculation processing in the visible band. RLItoner_sum of the calculation formula F3r is the cumulative value of RLItoner λ in the visible band (for example, a wavelength 400 nm to 730 nm). GLItoner_sum of the calculation formula F3g is the cumulative value of GLItoner λ in the visible band (wavelength 400 nm to 730 nm). BLItoner_sum of the calculation formula F3b is the cumulative value of BLItoner λ in the visible band (wavelength 400 nm to 730 nm).

That is, RLItoner_sum is a cumulative value of the light receiving intensity in the visible band received by the light receiving element 122R. GLItoner_sum is a cumulative value of the light receiving intensity in the visible band received by the light receiving element 122G. BLItoner_sum is a cumulative value of the light receiving intensity of the visible band received by the light receiving element 122B.

In step S400, the color calibration processing unit 211 calculates cumulative values of the light receiving intensities in the visible band of the reflection light of the ink received by the three light receiving elements 122R, 122G, and 122B, respectively, by using the calculation formulas F5r, F5g, and F5b, and the calculation formulas F6r, F6g, and F6b.

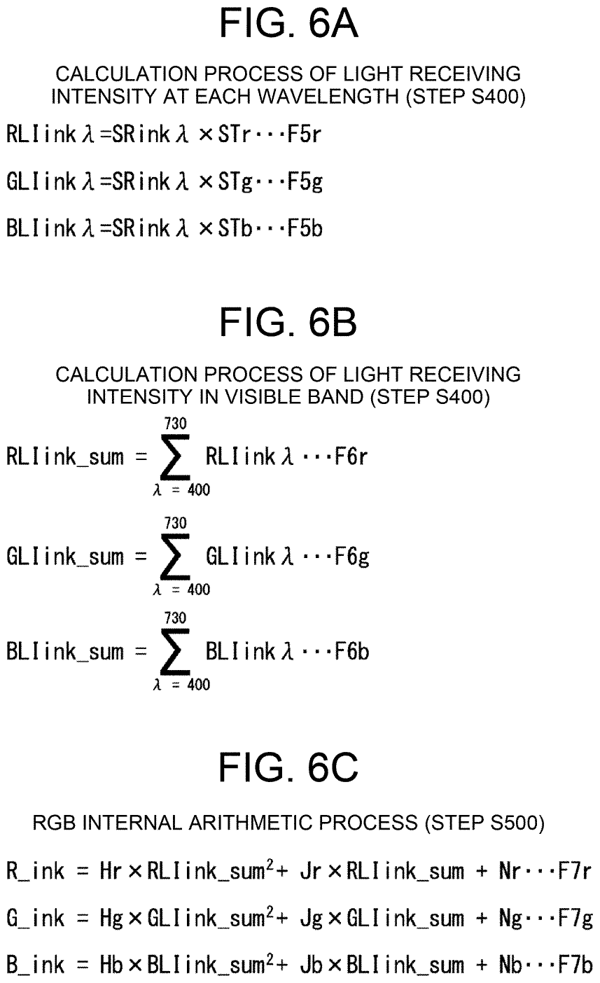

FIGS. 6A, 6B and 6C are each an explanatory diagram showing the contents of the RGB arithmetic processing of the ink reproduction color according to the embodiment. FIG. 6A shows calculation formulas F5r, F5g, and F5b used in the light receiving intensity calculation processing for each wavelength. RLIinkλ in the calculation formula F5r is the light receiving intensity for each wavelength of R. SRinkλ is the ink spectral reflectance. STrλ is the spectral transmittance at the wavelength λ nm of the R color filter CFR. GLIinkλ in the calculation formula F5g is the light receiving intensity for each wavelength of G. SRinkλ is the ink spectral reflectance. STgλ is the spectral transmittance at the wavelength λ nm of the G color filter CFG. BLIinkλ in the calculation formula F5b is the light receiving intensity for each wavelength of B. SRinkλ is the ink spectral reflectance. STbλ is the spectral transmittance at the wavelength λ nm of the B color filter CFB.

FIG. 6B shows calculation formulas F6r, F6g, and F6b used for the light receiving intensity calculation processing in the visible band. RLIink_sum of the calculation formula F6r is an cumulative value of RLIinkλ in the visible band (for example, a wavelength 400 nm to 730 nm). GLIink_sum of the calculation formula F6g is the cumulative value of GLIinkλ in the visible band (wavelength 400 nm to 730 nm). BLIink_sum in the calculation formula F6b is the cumulative value of BLIinkλ in the visible band (wavelength 400 nm to 730 nm).

That is, RLIink_sum is an cumulative value of the light receiving intensity of the visible band received by the light receiving element 122R. GLIink_sum is the cumulative value of the light receiving intensity of the visible band received by the light receiving element 122G. BLIink_sum is the cumulative value of the light receiving intensity of the visible band received by the light receiving element 122B.

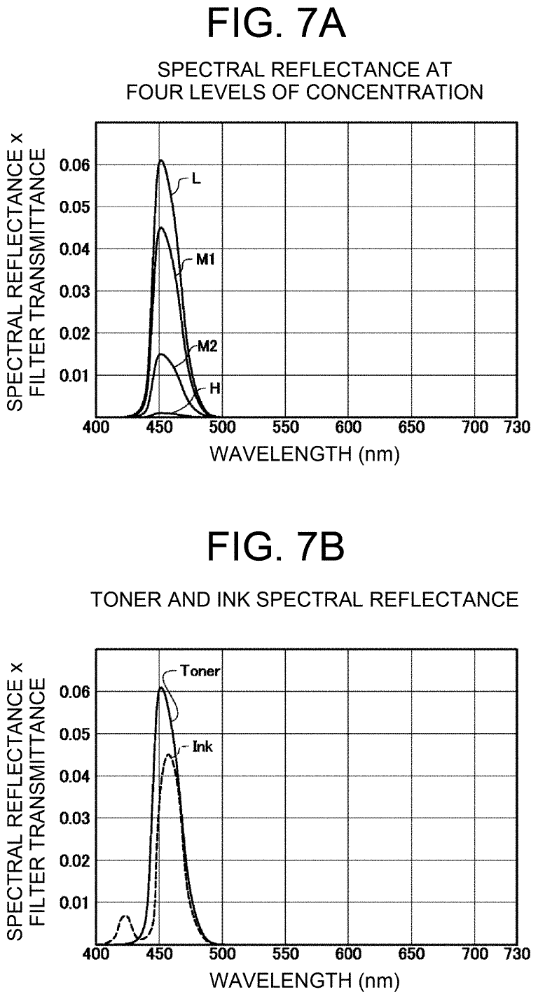

FIGS. 7A and 7B are each a graph showing the product of the spectral reflectance and the filter transmittance in the visible band according to an embodiment. FIG. 7A shows the product of the spectral reflectance and the filter transmittance (color filter CFB) at the four levels of the yellow toner concentration in the visible band. Yellow toner is a toner that absorbs the color B and reproduces the color yellow. In the present embodiment, each of the three light receiving elements 122R, 122G, and 122B outputs a voltage according to the light receiving intensity in the visible light band, and has substantially the same characteristics.

The first curve L represents the product of the spectral reflectance and the filter transmittance of the background of the printing paper on which the yellow toner is not formed. The second curve M1 represents the product of the spectral reflectance and the filter transmittance of the background of the printing paper on which the yellow toner is formed relatively thin. The third curve M2 represents the product of the spectral reflectance and the filter transmittance of the background of the printing paper on which the yellow toner is formed relatively thick. The fourth curve H represents the product of the spectral reflectance and the filter transmittance of the background of the printing paper on which the solid yellow toner is formed.

In this manner, the three light receiving elements 122R, 122G, and 122B output voltages according to the light receiving intensity in the visible light band with substantially the same characteristics, to detect RGB light according to the transmittance characteristics of the color filters CFR, CFG, and CFB, respectively. Therefore, the RGB gradation value has a high positive correlation with the integrated value (or cumulative value) of the product of the spectral reflectance and the spectral transmittance of the wavelength in the visible light band or the band preset to have each characteristic of RGB.

In step S500, the color calibration processing unit 211 calculates the gradation values R_toner, G_toner, and B_toner of RGB from RLItoner_sum, GLItoner_sum, and BLItoner_sum, respectively, using the approximate conversion formulas F4r, F4g, and F4b stored in the storage unit 240 in advance.

In step S500, the color calibration processing unit 211 calculates the gradation values R_ink, G_ink, and B_ink of RGB from the RLIink_sum, GLIink_sum, and BLIink_sum, respectively, using the approximate conversion formulas F7r, F7g, and F7b stored in the storage unit 240 in advance.

FIG. 7B is an explanatory diagram illustrating the contents of the RGB arithmetic processing of the ink reproduction color according to the embodiment, and is a graph showing the spectral reflectance of the toner and ink in comparison. In the present disclosure, it is confirmed through simulations and experiments that the spectral reflectance of toner (an example of an image forming color material) and ink (a reference ink) for reproducing the same color or a similar color has an approximate distribution shape, however is different in details, and the ratio of cumulative values (integrated values) in the visible region is approximately constant (i.e., approximately linear).

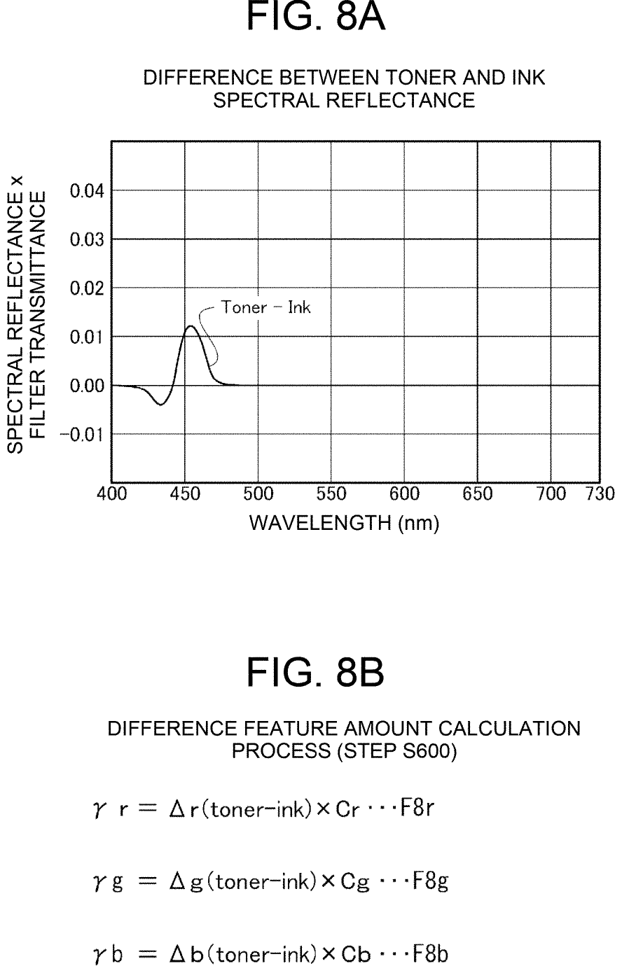

FIGS. 8A and 8B are each an explanatory diagram showing a spectral reflectance difference and a difference feature amount according to an embodiment. FIG. 8A is a graph showing the difference in spectral reflectance between toner and ink. In the present disclosure, it is noticed that when the spectral reflectance of the toner and the ink is compared, a difference has occurred in a part of the wavelength band, which is a cause of non-linearity. In this example, the spectral reflectance of the toner and ink is different in the wavelength band where R has a negative value in the RGB isochromatic function. As for the nonlinearity, the difference in spectral reflectance is not significantly affected by the blank area in the low concentration region, but is significantly affected in the high concentration region.

In step S600, the color calibration processing unit 211 executes the difference feature amount calculation processing. In the difference feature amount calculation processing, the color calibration processing unit 211 calculates the respective difference feature amounts yr, yg and yb of RGB using the calculation formulas F8r, F8g and F8b (see FIG. 8B).

The difference feature amount includes a first correction coefficient (In the example of the calculation formula F8r, Δr (toner-ink)) and a second correction coefficient (in the example of the calculation formula F8r, Cr). By using the difference feature amount, it is possible to simulate calibration using a printed matter using toner as the image forming color material by using a reference document (in this example, INK document Di) prepared by low-cost offset printing with small variation in quality between printed matters. In order to realize such a simulation with high accuracy, it is preferable that the reference inks of a plurality of colors used for image formation of the INK document Di can reproduce colors of a wider color gamut than the image forming color materials of a plurality of colors.

The first correction coefficient is a correction coefficient (linear correction amount) as a ratio set on the basis of the linearity of the spectral reflectance of the toner and the ink, and is commonly used for the whole gradation region of each value of RGB. The second correction coefficient is a correction coefficient (nonlinear correction amount) set on the basis of the linearity of the spectral reflectance of the toner and the ink. The second correction coefficient is a correction coefficient individually set for each patch of 48 gradations of each color material of CMYK of the INK document Di, that is, for each of 192 patches.

The first correction coefficient can be calculated, for example, by curve fitting (linear regression analysis). The second correction coefficient can be calculated as a correction coefficient for reducing an error remaining after correction by the first correction coefficient. It should be noted that the first correction coefficient and the second correction coefficient may be calculated using another calculation method, for example, a difference feature amount may be calculated by using a difference in the spectral reflectance in the visible region of the color material image obtained by simulating the INK document Di and the image forming color material and a difference integrated value which is the integrated value of the product of the difference in the spectral transmittance.

In step S700, the image reading unit 100 executes image reading of the INK document Di (see FIG. 4A), and multiplies each acquired gradation value of RGB by each difference feature amount yr, yg, yb of RGB. Here, each gradation value between patches can be set by internal interpolation. By doing so, the image reading unit 100 can acquire an RGB value equivalent to the toner output paper when toner is used instead of ink as the color material.

In step S800, the color calibration processing unit 211 executes conversion formula generation processing. In the conversion formula generation processing, the color calibration processing unit 211 generates an approximate conversion formula from the RGB value corresponding to the toner output paper to the XYZ value using the XYZ value acquired in step S200 and the RGB value corresponding to the toner output paper. In this specification, an approximate conversion formula has a broad meaning and includes an approximation formula and a table.

In step S900, the color calibration processing unit 211 updates the input profile, the output profile, and the device link profile using the approximate conversion formula, and stores them in the storage unit 240.

In the prior art, by providing an in-line colorimeter for each image forming apparatus, a good halftone expression can be realized by creating an individual conversion formula according to the type of paper and process conditions, but since the variation of the in-line colorimeter is included, the absorption of the individual difference of the image forming apparatus has limitations. In addition, there is a problem that mounting a colorimeter on an image forming apparatus increases the size and cost of the apparatus. Further, such a problem is not limited to the electrophotographic image formation but is also a common problem in the inkjet image formation.

As described above, the image forming apparatus 10 according to one embodiment is configured to be capable of color calibration by using a reference document generated by using a plurality of inks including CMY ink as a color material and an external colorimeter. Thus, the image forming apparatus 10 can suppress individual differences in color reproduction of the image forming apparatus with a simple configuration.

Modification: The present disclosure can be practiced not only in the above embodiment but also in the following modifications.

Modification 1: In the above embodiment, the image forming apparatus 10 adopts an electro-photographic process system using toner as the image forming color material, but the present disclosure is also applicable to, for example, an inkjet printing system using ink as the image forming color material. The present disclosure is widely applicable to image formation in which a plurality of color materials including a CMY color material are used as an image forming color material to form an image on an image forming medium.

Modification 2: In the above embodiment, the difference feature amount is determined using the ratio between the cumulative value in the visible region of the spectral reflectance of the reference document and the cumulative value in the visible region of the spectral reflectance of the toner image, but may be determined using, for example, a preset cumulative value in each band of RGB.

Modification 3: In the above embodiment, the difference feature amount is set for each patch of each color of RGB, but may be set for each color of RGB. By doing so, the present disclosure can be applied even if the ratio of the spectral reflectance of the toner and the ink is assumed to be linear.

What is claimed is:

1. An image forming apparatus capable to perform color calibration by using a reference document generated by offset printing using reference inks of a plurality of colors including CMY, and an external colorimeter capable of measuring a spectral reflectance in a visible region and an XYZ value, comprising:
an image reading unit that reads an image on a document to generate image data;
an image forming unit that forms an image on an image forming medium using image forming color materials of a plurality of colors including CMY; and
a color calibration processing unit that sets, in consideration of an integrated value of the product of the spectral transmittance and the spectral reflectance in the visible region of the reference document measured by the external colorimeter and a color material image formed using the image forming color materials on the image forming medium, a difference feature amount for bringing the color of the color material image closer to the color of the reference document by using the integrated value of the product of the spectral transmittance and the spectral reflectance in the visible region calculated from the XYZ value measured by the external colorimeter, wherein
the color calibration processing unit corrects each gradation value of RGB obtained by reading the reference document by the image reading unit by multiplying the gradation value by the difference feature amount, generates, by using the corrected each gradation value of RGB and each device-independent value obtained by measuring the reference document by the external colorimeter, a conversion formula from the obtained each gradation value of RGB to the each device-independent value, and generates a color profile by using the conversion formula, and
the difference feature amount includes a linear correction amount that is a ratio set based on linearity between the spectral reflectance in the visible region of the color material image and the spectral reflectance in the visible region of the reference document, and a nonlinear correction amount that represents non-linearity between the spectral reflectance in the visible region of the color material image and the spectral reflectance in the visible region of the reference document.

2. The image forming apparatus according to claim 1, wherein
the color calibration processing unit determines the difference feature amount by using a difference in spectral reflectance in a visible region of the reference document and the color material image and a difference integrated value which is an integrated value of a product of a difference in spectral transmittance.

3. The image forming apparatus according to claim 1, wherein
the color calibration processing unit calculates a spectral reflectance for reproducing the device-independent value in the color material image by calculating the device-independent value obtained by using the external colorimeter using a predetermined quadratic or higher approximation conversion formula.

4. The image forming apparatus according to claim 1, wherein
the reference inks of the plurality of colors are capable of reproducing colors of a wider color gamut than the image forming color materials of the plurality of colors.

5. The image forming apparatus according to claim 1, wherein
the image forming apparatus forms an image by an electro-photographic method,
and the image forming color materials of the plurality of colors are toner.

6. The image forming apparatus according to claim 1, wherein
the image forming apparatus forms an image by an ink jet method,
and the image forming color materials of the plurality of colors are ink.

7. An image forming method capable to perform color calibration by using a reference document generated by offset printing using reference inks of a plurality of colors including CMY, and an external colorimeter capable of measuring a spectral reflectance in a visible region and an XYZ value, comprising:
an image reading step of reading an image on a document to generate image data;
an image forming step of forming an image on an image forming medium using image forming color materials of a plurality of colors including CMY; and
a color calibration processing step of setting, in consideration of the integrated value of the product of the spectral transmittance and the spectral reflectance in the visible region of the reference document measured by the external colorimeter and a color material image formed using the image forming color materials on the image forming medium, a difference feature amount for bringing the color of the color material image closer to the color of the reference document by using the integrated value of the product of the spectral transmittance and the spectral reflectance in the visible region calculated from the XYZ value measured by the external colorimeter, wherein
the color calibration processing step of correcting each gradation value of RGB obtained by reading the reference document in the image reading step by multiplying the gradation value by the difference feature amount, generating, by using the corrected each gradation value of RGB and each device-independent value obtained by measuring the reference document by the external colorimeter, a conversion formula from the obtained each gradation value of RGB to the each device-independent value, and generating a color profile by using the conversion formula, and
the difference feature amount includes a linear correction amount that is a ratio set based on linearity between the spectral reflectance in the visible region of the color material image and the spectral reflectance in the visible region of the reference document, and a nonlinear correction amount that represents non-linearity between the spectral reflectance in the visible region of the color material image and the spectral reflectance in the visible region of the reference document.

8. A non-transitory computer-readable recording medium that stores an image forming program to control an image forming apparatus capable to perform color calibration by using a reference document generated by offset printing using reference inks of a plurality of colors including CMY, and an external colorimeter capable of measuring a spectral reflectance in a visible region and an XYZ value, the image forming program causing the image forming apparatus to function as:
an image reading unit that reads an image on a document to generate image data;
an image forming unit that forms an image on an image forming medium using image forming color materials of a plurality of colors including CMY; and
a color calibration processing unit that sets, in consideration of an integrated value of the product of the spectral transmittance and the spectral reflectance in the visible region of the reference document measured by the external colorimeter and a color material image formed using the image forming color materials on the image forming medium, a difference feature amount for bringing the color of the color material image closer to the color of the reference document by using the integrated value of the product of the spectral transmittance and the spectral reflectance in the visible region calculated from the XYZ value measured by the external colorimeter, wherein
the color calibration processing unit corrects each gradation value of RGB obtained by reading the reference document by the image reading unit by multiplying the gradation value by the difference feature amount, generates, by using the corrected each gradation value of RGB and each device-independent value obtained by measuring the reference document by the external colorimeter, a conversion formula from the obtained each gradation value of RGB to the each device-independent value, and generates a color profile by using the conversion formula, and
the difference feature amount includes a linear correction amount that is a ratio set based on linearity between the spectral reflectance in the visible region of the color material image and the spectral reflectance in the visible region of the reference document, and a nonlinear correction amount that represents non-linearity between the spectral reflectance in the visible region of the color material image and the spectral reflectance in the visible region of the reference document.
